(19) United States
(12) Patent Application Publication
(10) Pub. No.: US 2024/0297351 A1
(43) Pub. Date: Sep. 5, 2024

(54) NONAQUEOUS ELECTROLYTE SOLUTION SECONDARY BATTERY, AND INSPECTION METHOD FOR NEGATIVE ELECTRODE FOR NONAQUEOUS ELECTROLYTE SOLUTION SECONDARY BATTERY

(71) Applicant: Prime Planet Energy & Solutions, Inc., Tokyo (JP)

(72) Inventors: Takehiro OGURA, Kobe-shi (JP); Kentaro TSUKAMOTO, Kobe-shi (JP)

(21) Appl. No.: 18/581,385

(22) Filed: Feb. 20, 2024

(30) Foreign Application Priority Data
Mar. 2, 2023 (JP) 2023-031577

(51) Int. Cl. H01M 10/0587; H01M 4/02; H01M 4/36; H01M 10/0567; H01M 10/42

(52) U.S. Cl. CPC H01M 10/0587; H01M 4/366; H01M 10/0567; H01M 10/42; H01M 2004/021; H01M 2004/027

(57) ABSTRACT

A nonaqueous electrolyte solution secondary battery disclosed herein includes an electrode body in which a positive electrode and a negative electrode are stacked across a separator. The negative electrode includes a negative electrode active material layer. The negative electrode active material layer includes a film containing a boron element. When the negative electrode active material layer existing in a central area of the electrode body is measured using a spectrophotometer, a b* value in an L*a*b* color system based on JIS Z8781-4: 2013 of Japan Industrial Standard is 3 or less.

### CROSS REFERENCE TO RELATED APPLICATION

This application claims the benefit of priority to Japanese Patent Application No. 2023-031577 filed on Mar. 2, 2023. The entire contents of this application are hereby incorporated herein by reference.

### BACKGROUND OF THE DISCLOSURE

### 1. Field

The present disclosure relates to a nonaqueous electrolyte solution secondary battery, and an inspection method for a negative electrode for a nonaqueous electrolyte solution secondary battery.

### 2. Background

A nonaqueous electrolyte solution secondary battery that includes an electrode body including a positive electrode and a negative electrode, and a nonaqueous electrolyte solution has been known conventionally. In the nonaqueous electrolyte solution secondary battery, at initial charging, a part of the nonaqueous electrolyte solution is decomposed and a film including a decomposition product thereof (solid electrolyte interface film: SEI film) is deposited on a surface of the negative electrode. By this film, an interface between the negative electrode and the nonaqueous electrolyte solution is stabilized and thus, the battery performance can be improved. Conventional technical literatures related to this include

According to Japanese Patent Application Publication No. 2007-165125, an oxalato complex compound containing a boron element or an oxalato complex compound containing a phosphorus element is added to a nonaqueous electrolyte solution as an additive (so-called film formation agent), so that the durability of a nonaqueous electrolyte solution secondary battery can be improved.

### SUMMARY

According to the present inventors' examination, however, in a case of applying the aforementioned technique to recent nonaqueous electrolyte solution secondary batteries with higher capacity, there is still room for improvement. That is to say, in the nonaqueous electrolyte solution secondary batteries with the higher capacity, for example, an electrode body is wider or an active material layer has higher density, in which case the additive permeates into a central area of the electrode body less easily. Accordingly, at initial charging, a film including a decomposition product of the additive is not formed easily on a surface of a negative electrode at a part existing in the central area of the electrode body. That is to say, between the central area of the electrode body and the other areas, unevenness occurs easily in terms of the quantity or the quality of the film formed on the negative electrode. As a result, it has been found out newly that the thermal stability of the negative electrode in the central area tends to decrease locally and for example, temperature increases easily at overcharging or the like.

The present disclosure has been made in view of the above circumstances, and an object is to provide a nonaqueous electrolyte solution secondary battery with improved thermal stability, and an inspection method for a negative electrode for a nonaqueous electrolyte solution secondary battery.

A nonaqueous electrolyte solution secondary battery according to the present disclosure includes an electrode body in which a positive electrode and a negative electrode are stacked across a separator, a nonaqueous electrolyte solution, and a battery case that accommodates the electrode body and the nonaqueous electrolyte solution. The negative electrode includes a negative electrode current collector and a negative electrode active material layer fixed on the negative electrode current collector. The negative electrode active material layer includes a film containing a boron element. When the negative electrode active material layer existing in a central area of the electrode body is measured using a spectrophotometer, a b* value in an L*a*b* color system based on JIS Z8781-4: 2013 of Japan Industrial Standard is 3 or less.

The present inventors have found out that unevenness of the quantity or the quality of the film appears as “color unevenness”. In addition, it has been discovered that there is a positive correlation between the b* value of the negative electrode active material layer existing in the central area of the electrode body and a heat generation quantity of the battery. In view of this, the b* value is adjusted to be less than or equal to a predetermined value in the present disclosure. Thus, the thermal stability of the central area of the electrode body can be improved and additionally, the temperature increase of the battery at overcharging or the like can be suppressed. By using the objective numeral obtained by the measurement with the spectrophotometer as an indicator, the accuracy varies less easily relatively compared to a case in which the color unevenness of the negative electrode active material layer is distinguished with human eyes, for example. Thus, the battery that can improve the thermal stability stably and has high reliability can be provided.

An inspection method for a negative electrode for a nonaqueous electrolyte solution secondary battery according to the present disclosure includes: a constructing step of constructing a battery assembly by accommodating, in a battery case, an electrode body in which a positive electrode including a positive electrode active material layer and a negative electrode including a negative electrode active material layer are stacked across a separator, and a nonaqueous electrolyte solution including a solvent, an electrolyte salt, and a compound containing a boron element; a charging step of charging the battery assembly until at least the compound containing the boron element is decomposed; a disassembling step of disassembling the battery assembly after the charging step; and a color measuring step of, after the disassembling step, measuring a b* value in an L*a*b* color system based on JIS Z8781-4: 2013 of Japan Industrial Standard about the negative electrode active material layer existing in a central area of the electrode body using a spectrophotometer.

In the color measuring step, the degree of heat generation of the battery can be predicted or confirmed with high accuracy by measuring the b* value of the negative electrode existing in the central area of the electrode body by the measurement with the spectrophotometer.

Although there is no relation with the present disclosure, Japanese Patent Application Publication No. 2008-010320 discloses an inspection method for an electrode current collector, in which whether an electrode current collector formed of copper or a copper alloy is good or bad is determined using a spectrophotometer.

The above and other elements, features, steps, characteristics and advantages of the

present disclosure will become more apparent from the following detailed description of the preferred embodiments with reference to the attached drawings.

### BRIEF DESCRIPTION OF THE DRAWINGS

FIG. 1 is a perspective view schematically illustrating a nonaqueous electrolyte solution secondary battery according to an embodiment;

FIG. 2 is a schematic longitudinal cross-sectional view taken along line II-II in FIG. 1;

FIG. 3 is a perspective view schematically illustrating an electrode body;

FIG. 4 is a schematic view illustrating a structure of the electrode body;

FIG. 5 is a graph expressing a relation between a first aging period of a first aging step and a b* value of a negative electrode active material layer;

FIG. 6 is a graph expressing a relation between a heat generation quantity of a battery and the b* value of the negative electrode active material layer;

FIG. 7 is a graph expressing a relation between the b* value of the negative electrode active material layer and a b* value of a separator; and

FIG. 8 is a graph expressing a relation between the heat generation quantity of the battery and the b* value of the separator.

### DETAILED DESCRIPTION OF THE PREFERRED EMBODIMENTS

Hereinafter, some preferred embodiments of the art disclosed herein will be described with reference to the drawings. Note that matters other than matters particularly mentioned in the present specification and necessary for the implementation of the present disclosure (for example, the general configuration and manufacturing process of a nonaqueous electrolyte solution secondary battery that do not characterize the present disclosure) can be grasped as design matters of those skilled in the art based on the prior art in the relevant field. The present disclosure can be implemented on the basis of the disclosure of the present specification and common technical knowledge in the relevant field. Note that in the present specification, the notation “A to B” for a range signifies a value more than or equal to A and less than or equal to B, and is meant to encompass also the meaning of being “more than A” and “less than B”.

In the present specification, the term “nonaqueous electrolyte solution secondary battery” refers to a general power storage device capable of being repeatedly charged and discharged by transfer of charge carriers between a positive electrode and a negative electrode through a nonaqueous electrolyte solution. The nonaqueous electrolyte solution secondary battery refers to a concept that encompasses a so-called storage battery such as a lithium ion secondary battery, and a capacitor such as a lithium ion capacitor and an electric double-layer capacitor.

### Battery 100

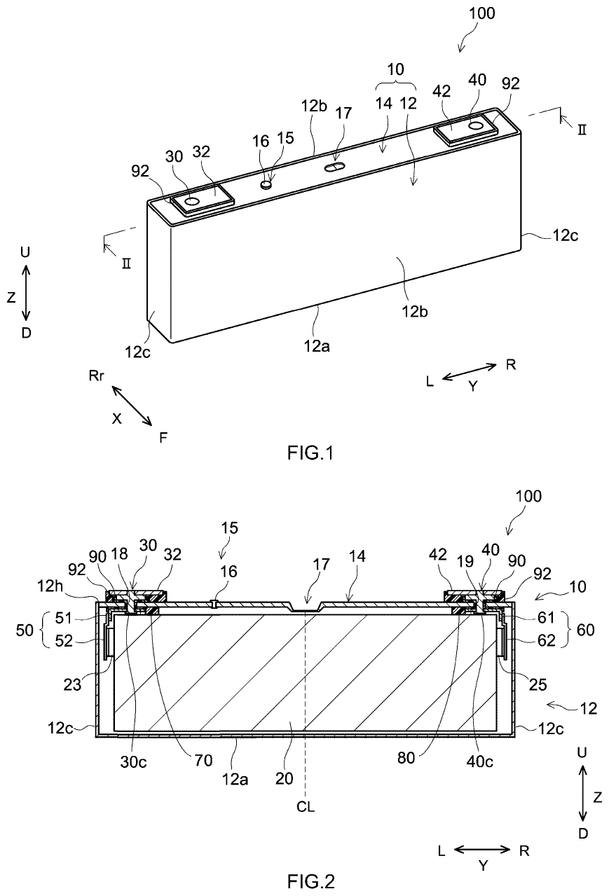

FIG. 1 is a perspective view of a nonaqueous electrolyte solution secondary battery (hereinafter, also referred to as a battery simply) 100. FIG. 2 is a schematic longitudinal cross-sectional view taken along line II-II in FIG. 1. In the following description, reference signs L, R, F, Rr, U, and D in the drawings respectively denote left, right, front, rear, up, and down, and reference signs X, Y, and Z in the drawings respectively denote a short side direction of the battery 100, a long side direction that is orthogonal to the short side direction, and an up-down direction that is orthogonal to the short side direction and the long side direction. These directions are defined however for convenience of explanation, and do not limit the manner in which the battery 100 is disposed.

As illustrated in FIG. 2, the battery 100 includes a battery case 10, an electrode body 20, a positive electrode terminal 30, a negative electrode terminal 40, a positive electrode current collecting part 50, a negative electrode current collecting part 60, a positive electrode insulating member 70, a negative electrode insulating member 80, and a nonaqueous electrolyte solution (not illustrated). The battery 100 is a lithium ion secondary battery here. The battery 100 is preferably the lithium ion secondary battery.

The battery case 10 is a housing that accommodates the electrode body 20 and the nonaqueous electrolyte solution. As illustrated in FIG. 1, the external shape of the battery case 10 here is a flat and bottomed cuboid shape (rectangular shape). A conventionally used material can be used for the battery case 10, without particular limitations. The battery case 10 is preferably made of a metal, and for example, more preferably made of aluminum, an aluminum alloy, iron, an iron alloy, or the like. As illustrated in FIG. 2, the battery case 10 includes an exterior body 12 having an opening 12h, and a sealing plate (lid body) 14 that covers the opening 12h. The battery case 10 preferably includes the exterior body 12 and the sealing plate 14.

As illustrated in FIG. 1, the exterior body 12 includes a bottom wall 12a with a substantially rectangular shape, a pair of long side walls 12b extending from long sides of the bottom wall 12a and facing each other, and a pair of short side walls 12c extending from short sides of the bottom wall 12a and facing each other. The bottom wall 12a faces the opening 12h. The long side wall 12b is larger in area than the short side wall 12c. Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

As illustrated in FIG. 1, the sealing plate 14 is substantially rectangular in shape in a plan view. As illustrated in FIG. 2, the sealing plate 14 is attached to the exterior body 12 so as to cover the opening 12h of the exterior body 12. The sealing plate 14 faces the bottom wall 12a of the exterior body 12. The battery case 10 is unified in a manner that the sealing plate 14 is joined (for example, joined by welding) to a periphery of the opening 12h of the exterior body 12. The battery case 10 is hermetically sealed (closed).

As illustrated in FIG. 2, the sealing plate 14 is provided with a liquid injection hole 15, a gas discharge valve 17, and two terminal extraction holes 18 and 19. The liquid injection hole 15 is a hole for injecting the nonaqueous electrolyte solution after the sealing plate 14 is assembled to the exterior body 12. The sealing plate 14 is preferably provided with the liquid injection hole 15. The liquid injection hole 15 is sealed by a sealing member 16. The gas discharge valve 17 is configured to break when pressure inside the battery case 10 reaches a predetermined value or more and discharge a gas in the battery case 10 to the outside. The terminal extraction holes 18 and 19 are formed in both end parts of the sealing plate 14 in the long side direction Y (left end part and right end part in FIG. 2, respectively). The terminal extraction holes 18 and 19 penetrate the sealing plate 14 in a thickness direction (up-down direction Z). The terminal extraction holes 18 and 19 respectively have the inner diameters that enable penetration of the positive electrode terminal 30 and the negative electrode terminal 40 before the electrode terminals are attached to the sealing plate 14 (before a caulking process).

Each of the positive electrode terminal 30 and the negative electrode terminal 40 is fixed to the sealing plate 14 of the battery case 10. The positive electrode terminal 30 is disposed on one side of the sealing plate 14 in the long side direction Y (left side in FIG. 1 and FIG. 2). The negative electrode terminal 40 is disposed on the other side of the sealing plate 14 in the long side direction Y (right side in FIG. 1 and FIG. 2). As illustrated in FIG. 2, the positive electrode terminal 30 is inserted to the terminal extraction hole 18 and extends to the outside from the inside of the sealing plate 14, and the negative electrode terminal 40 is inserted to the terminal extraction hole 19 and extends to the outside from the inside of the sealing plate 14. The positive electrode terminal 30 and the negative electrode terminal 40 are preferably attached to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 2).

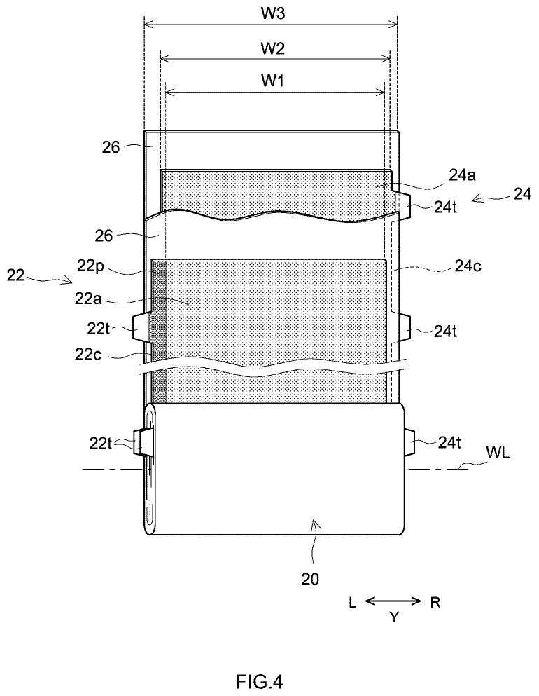

As illustrated in FIG. 2, the positive electrode terminal 30 is electrically connected to a positive electrode 22 (see FIG. 4, in detail, positive electrode tab group 23) of the electrode body 20 through the positive electrode current collecting part 50 inside the battery case 10. The positive electrode terminal 30 is insulated from the sealing plate 14 by the positive electrode insulating member 70 and a gasket 90. The positive electrode terminal 30 is preferably formed of a metal and is more preferably formed of, for example, aluminum or an aluminum alloy.

On the other hand, the negative electrode terminal 40 is electrically connected to a negative electrode 24 (see FIG. 4, in detail, negative electrode tab group 25) of the electrode body 20 through the negative electrode current collecting part 60 inside the battery case 10. The negative electrode terminal 40 is insulated from the sealing plate 14 by the negative electrode insulating member 80 and the gasket 90. The negative electrode terminal 40 is preferably formed of a metal and is more preferably formed of, for example, copper or a copper alloy. The negative electrode terminal 40 may be configured of two conductive members joined together and integrated. In the negative electrode terminal 40, for example, a part connected to the negative electrode current collecting part 60 may be formed of copper or a copper alloy, and a part exposed on an outer surface of the sealing plate 14 may be formed of aluminum or an aluminum alloy.

A positive electrode external conductive member 32 and a negative electrode external conductive member 42, each having a plate shape, are attached to the outer surface of the sealing plate 14. The positive electrode external conductive member 32 and the negative electrode external conductive member 42 are members to which a busbar is attached when a plurality of the batteries 100 are electrically connected to each other. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are insulated from the sealing plate 14 by an external resin member 92. The positive electrode external conductive member 32 and the negative electrode external conductive member 42 are preferably formed of a metal and are more preferably formed of, for example, aluminum or an aluminum alloy. However, the positive electrode external conductive member 32 and the negative electrode external conductive member 42 are not always necessary and can be omitted in another embodiment.

As illustrated in FIG. 2, the electrode body 20 is accommodated inside the battery case 10 (in detail, inside the exterior body 12). The number of electrode bodies 20 to be disposed inside one battery case 10 is not limited in particular, and may be one, or two or more (plural). The electrode body 20 may be disposed inside the battery case 10 in a state of being covered with an electrode body holder with an insulating property. In other words, the electrode body holder may exist between the electrode body 20 and the battery case 10 (in detail, exterior body 12). For example, the electrode body holder may have a box shape, and the electrode body 20 may be disposed therein. The electrode body holder is preferably made of resin.

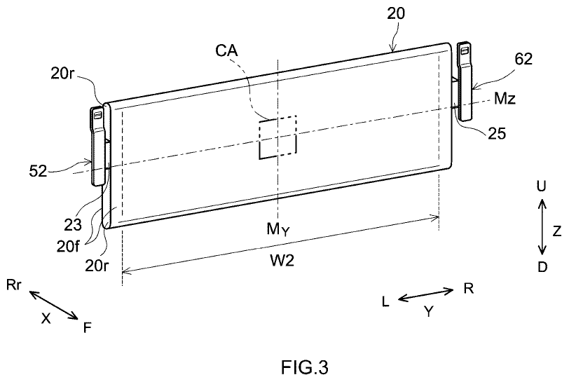

FIG. 3 is a perspective view schematically illustrating the electrode body 20. FIG. 4 is a schematic view illustrating a structure of the electrode body 20. As illustrated in FIG. 4, the electrode body 20 includes the positive electrode 22, the negative electrode 24, and a separator 26. The electrode body 20 here is a wound electrode body. The electrode body 20 has a structure in which the positive electrode 22 with a band shape and the negative electrode 24 with a band shape are stacked across the separator 26 with a band shape and wound using a winding axis WL as a center. In another embodiment, the electrode body 20 may be a stack type electrode body formed in a manner that a plurality of square positive electrodes and a plurality of square negative electrodes are stacked in the insulated state across the separator.

Although not limited in particular, the number of winding turns (the number of turns) of the electrode body 20 is preferably 20 turns or more, more preferably 30 turns or more, and still more preferably 50 turns or more, and may be 150 turns or less and 100 turns or less, for example. When the number of winding turns is larger, the nonaqueous electrolyte solution permeates less easily into a central area CA (see FIG. 3) of the electrode body 20, in particular, into a central part in the short side direction X and unevenness of the quantity or the quality of a film occurs more easily. Thus, it is particularly effective to apply the art disclosed herein.

The electrode body 20 is preferably the wound electrode body. As illustrated in FIG. 3, when the electrode body 20 is the wound electrode body, the nonaqueous electrolyte solution is supplied from only both end parts in the long side direction Y (winding axis WL direction). Thus, the nonaqueous electrolyte solution does not permeate easily sufficiently into the central area CA of the electrode body 20 in particular. Therefore, the unevenness of the quantity or the quality of the film easily occurs between the central area CA and the other part of the electrode body 20, for example, between a central part and an end part in the long side direction Y. Thus, it is particularly effective to apply the art disclosed herein.

Note that, in the present specification, the term “central area CA of the electrode body 20” refers to a central area on a surface that is orthogonal to a stacking direction (thickness direction) as illustrated in FIG. 3, and specifically refers to a central part (for example, within a frame indicated by a two-dot chain line in FIG. 3) including a center M_{Y} in the long side direction Y (winding axis WL direction) and a center M_{Z} in the up-down direction Z. In the case where the electrode body 20 is the wound electrode body as described in the present embodiment, additionally, the central area CA refers to an intermediate peripheral part in the winding direction (the number of turns).

As illustrated in FIG. 2 and FIG. 3, the electrode body 20 here is disposed inside the battery case 10 in a direction in which the winding axis WL is substantially parallel to the long side direction Y. The winding axis WL direction is a direction that coincides with the long side direction Y here. The electrode body 20 is disposed inside the battery case 10 in a direction in which the winding axis WL is parallel to the bottom wall 12a and orthogonal to the short side wall 12c.

The battery 100 here has a so-called lateral tab structure in which the positive electrode tab group 23 and the negative electrode tab group 25 exist on both ends of the electrode body 20 in the winding axis WL direction (left and right in FIG. 2 and FIG. 3). In another embodiment, however, the battery 100 may have a so-called upper tab structure in which the positive electrode tab group 23 and the negative electrode tab group 25 exist on one end of the electrode body 20 in the winding axis WL direction (for example, upper end part in FIG. 2 and FIG. 3). In this case, the winding axis WL direction may be a direction that coincides with the up-down direction Z.

As illustrated in FIG. 3, the external shape of the electrode body 20 is a flat shape. The external shape of the electrode body 20 is preferably a flat shape. The electrode body 20 includes a pair of flat parts 20f expanding along the long side direction Y (the winding axis WL direction), and a pair of curved parts (R parts) 20r coupling the pair of flat parts 20f. The flat part 20f includes a flat outer surface (YZ plane in FIG. 3). The curved part 20r includes a curved outer surface. Note that in the present specification, “flat outer surface” is not limited to a perfectly flat surface, and is a term that encompasses a case in which a small step, curve, concave part, convex part, or the like is included when viewed microscopically, for example.

As illustrated in FIG. 1 to FIG. 3, the pair of flat parts 20f face the pair of long side walls 12b of the exterior body 12. The flat part 20f extends along the long side wall 12b. The pair of curved parts 20r face the bottom wall 12a of the exterior body 12 and the sealing plate 14. The electrode body 20 is preferably disposed inside the battery case 10 in a manner that the stacking direction (thickness direction) of the positive electrode 22 (see FIG. 4) and the negative electrode 24 (see FIG. 4) of the flat part 20f coincides with the short side direction X (direction perpendicular to the long side wall 12b), as described in this embodiment.

The positive electrode 22 may be similar to the conventional positive electrode, without particular limitations. As illustrated in FIG. 4, the positive electrode 22 includes a positive electrode current collector 22c, and a positive electrode active material layer 22a and a positive electrode protection layer 22p that are fixed on at least one surface of the positive electrode current collector 22c. However, the positive electrode protection layer 22p is not essential, and can be omitted in another embodiment. The positive electrode current collector 22c has a band shape. The positive electrode current collector 22c is formed of, for example, a conductive metal such as aluminum, an aluminum alloy, nickel, or stainless steel. Here, the positive electrode current collector 22c is a metal foil, specifically an aluminum foil.

At one end part of the positive electrode current collector 22c in the long side direction Y (left end part in FIG. 4), a plurality of positive electrode tabs 22t are provided. The plurality of positive electrode tabs 22t protrude toward one side in the long side direction Y (left side in FIG. 4). The positive electrode tab 22t constitutes a part of the positive electrode current collector 22c here, and is made of a metal foil (aluminum foil). At least a part of the positive electrode tab 22t is a current collector exposing part in which the positive electrode active material layer 22a and the positive electrode protection layer 22p are not formed and the positive electrode current collector 22c is exposed. As illustrated in FIG. 3, the plurality of positive electrode tabs 22t are stacked at one end part in the long side direction Y (left end part in FIG. 3), and form the positive electrode tab group 23. The positive electrode tab group 23 is electrically connected to the positive electrode terminal 30 through the positive electrode current collecting part 50. A positive electrode second current collecting part 52 of the positive electrode current collecting part 50 to be described below is attached (in detail, joined) to the positive electrode tab group 23.

As illustrated in FIG. 4, the positive electrode active material layer 22a is provided to have a band shape along a longitudinal direction of the positive electrode current collector 22c with a band shape. The positive electrode active material layer 22a contains a positive electrode active material (for example, a lithium transition metal complex oxide such as a lithium nickel cobalt manganese complex oxide) capable of reversibly storing and releasing the charge carriers. The positive electrode active material layer 22a may contain any component other than the positive electrode active material, for example, a conductive material, a binder, various additive components, or the like. As the conductive material, for example, a carbon material such as acetylene black (AB) can be used. As the binder, for example, polyvinylidene fluoride (PVdF) or the like can be used.

Although not limited in particular, in the battery 100 of a high-capacity type as illustrated in FIG. 4, which is used for vehicles or the like, the width of the positive electrode active material layer 22a in the winding axis WL direction (average value, excluding a part formed in the positive electrode tab 22t), in other words, a length W1 in the long side direction Y is preferably 15 cm or more, more preferably 20 cm or more, and still more preferably 25 cm or more.

The positive electrode protection layer 22p is provided between the positive electrode current collector 22c and the positive electrode active material layer 22a in the long side direction Y as illustrated in FIG. 4. Here, the positive electrode protection layer 22p is provided at one end part (left end part in FIG. 4) of the positive electrode current collector 22c in the long side direction Y. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components. The conductive material and the binder may be the same as those described as the examples that may be contained in the positive electrode active material layer 22a.

As illustrated in FIG. 4, the negative electrode 24 includes a negative electrode current collector 24c and a negative electrode active material layer 24a that is fixed on at least one surface of the negative electrode current collector 24c. The negative electrode current collector 24c has a band shape. The negative electrode current collector 24c is formed of, for example, a conductive metal such as copper, a copper alloy, nickel, or stainless steel. Here, the negative electrode current collector 24c is a metal foil, specifically a copper foil.

At one end part of the negative electrode current collector 24c in the long side direction Y (right end part in FIG. 4), a plurality of negative electrode tabs 24t are provided. Each of the plurality of negative electrode tabs 24t protrudes toward one side in the long side direction Y (right side in FIG. 4). The negative electrode tab 24t constitutes a part of the negative electrode current collector 24c and is made of a metal foil (copper foil). At least a part of the negative electrode tab 24t is a current collector exposing part in which the negative electrode active material layer 24a is not formed and the negative electrode current collector 24c is exposed. As illustrated in FIG. 3, the plurality of negative electrode tabs 24t are stacked at one end part in the long side direction Y (right end part in FIG. 3) and form the negative electrode tab group 25. The negative electrode tab group 25 is electrically connected to the negative electrode terminal 40 through the negative electrode current collecting part 60. A negative electrode second current collecting part 62 of the negative electrode current collecting part 60 to be described below is attached (in detail, joined) to the negative electrode tab group 25.

As illustrated in FIG. 4, the negative electrode active material layer 24a is provided to have a band shape along the longitudinal direction of the negative electrode current collector 24c with a band shape. The negative electrode active material layer 24a contains a negative electrode active material (for example, a carbon material such as graphite) capable of reversibly storing and releasing the charge carriers. When a total solid content of the negative electrode active material layer 24a is set to 100 mass %, the negative electrode active material may occupy approximately 80 mass % or more, typically 90 mass % or more, and for example 95 mass % or more. The negative electrode active material layer 24a may contain any component other than the negative electrode active material, for example, a binder, a dispersing agent, various additive components, or the like. As the binder, for example, rubbers such as styrene-butadiene rubber (SBR) can be used. As the dispersing agent, for example, celluloses such as carboxymethyl cellulose (CMC) can be used.

Although not limited in particular, the negative electrode active material layer 24a has a density of preferably 0.5 g/cm³ or more, and more preferably 1.0 g/cm³ or more, for example, from the viewpoints of increasing the capacity and the like. Moreover, the negative electrode active material layer 24a has a density of preferably 2.0 g/cm³ or less, and more preferably 1.5 g/cm³ or less from the viewpoint of achieving the effect of the art disclosed herein at a high level.

In the present embodiment, the negative electrode active material layer 24a includes a film (SEI film) containing a boron (B) element. This boron is a component derived from a film formation agent that is added to the nonaqueous electrolyte solution when the battery 100 is constructed, specifically a component derived from a compound containing the boron element (B element containing compound). The aforementioned film is a decomposition product including the B element containing compound decomposed at initial charging. Since the film containing the boron element has excellent stability, the durability of the battery 100 can be improved suitably. The presence of the film containing the boron element can be confirmed by, for example, detecting the B element through a conventionally known method such as inductively coupled plasma (ICP) spectrometry, ion chromatography, or X-ray absorption fine structure (XAFS).

In the central area CA of the electrode body 20, the boron concentration ratio (B concentration ratio) of the negative electrode active material layer 24a is preferably 0.010% or more, for example 0.010 to 0.020%, and more preferably 0.012% or more. Note that the B concentration ratio can be measured and calculated in accordance with the following procedure. That is to say, first, the battery 100 is disassembled to extract the negative electrode 24, and the negative electrode 24 is decompressed (for example, −95 kPa for 10 minutes), so that a volatile component (for example, EMC, DMC, or VC to be described below) is removed. Next, the negative electrode 24 is punched into two pieces with a predetermined size (for example, 10×60 mm), which are then immersed in GBL (γ-butyrolactone) so that a nonvolatile component is extracted. Next, after the extracted solution is diluted with HCl and pure water, the quantity of the boron element (mg/cm²) is measured using ICP spectrometry. The presence ratio to the ideal composition based on a phosphorus element, that is, the presence ratio of an electrolyte salt to be described below based on LiPF₆ (100%) can be calculated.

In the present embodiment, when the negative electrode active material layer 24a (typically surface) existing in the central area CA of the electrode body 20 is measured using a spectrophotometer, a b* value in an L*a*b* color system based on JIS Z8781-4: 2013 of Japan Industrial Standard is 3 or less. In the L*a*b* color system, monochrome (brightness) and coordinate axes of yellow, blue, red, and green (chromaticity) can be divided. There is a positive correlation between the b* value of the negative electrode active material layer 24a that is obtained by measurement with a spectrophotometer and the heat generation quantity of the battery 100, which will be described below in detail in Example. Therefore, by adjusting the b* value of the negative electrode active material layer 24a existing in the central area CA of the electrode body 20 to be a predetermined value or less, the heat generation quantity of the central area CA can be suppressed and the thermal stability of the battery 100 can be improved.

Note that, according to the present inventors' examination, there is no strong correlation between the heat generation quantity of the battery 100 and the boron concentration ratio (B concentration ratio) of the negative electrode active material layer 24a existing in the central area CA of the electrode body 20. For example, even when the B concentration ratio is the same, the b* value may be different in some cases. Therefore, it is important to evaluate based on the b* value as described in the art disclosed herein.

The gradation of the film can be recognized as “color unevenness” by human eyes, for example; however, since human eyes are different from individual to individual, the result of determining whether there is a color unevenness may vary depending on the individuals. On the other hand, if the objective numerals obtained by the measurement with a spectrophotometer as described in the art disclosed herein are used as an indicator, the accuracy varies less easily relatively. In addition, even the color difference that cannot be determined by the human eyes can be distinguished. Thus, the battery 100 that can improve the thermal stability stably and has high reliability can be provided.

From the viewpoint of achieving the effect of the art disclosed herein at the high level, the b* value of the negative electrode active material layer 24a is preferably 2.5 or less, more preferably 2 or less, and still more preferably 1.5 or less. The b* value of the negative electrode active material layer 24a may be typically 1 or more and for example 1.2 or more. Note that the b* value can be adjusted suitably not just by the liquid injection quantity of the nonaqueous electrolyte solution or the concentration of the additive (the compound containing the boron element) in the nonaqueous electrolyte solution when the battery 100 is constructed, but also by the conditions in an electrolyte solution impregnation step (step 2), or the conditions in a first aging step (step 5) after the initial charging, a subsequent second aging step (step 6), and the like in a manufacturing method to be described below, for example. In particular, the b* value can be adjusted suitably by a first aging period in the first aging step or a second aging period in the second aging step.

The width of the negative electrode active material layer 24a in the winding axis WL direction (average value, excluding a part formed in the negative electrode tab 24t), in other words, a length W2 in the long side direction Y is more than or equal to the length W1 of the positive electrode active material layer 22a in the long side direction Y. Although not limited in particular, the length W2 is preferably 15 cm or more, more preferably 20 cm or more, and still more preferably 25 cm or more from the viewpoints of increasing the capacity and the like. As the length W2 is longer, the nonaqueous electrolyte solution permeates less easily into the central area CA of the electrode body 20, particularly into the central part in the long side direction Y, and the unevenness occurs more easily in the quantity or the quality of the film. Therefore, it is particularly effective to apply the art disclosed herein. The length W2 may be, for example, 100 cm or less and 50 cm or less. Thus, the effect of the art disclosed herein can be achieved at the high level.

Note that in the case where the length W2 of the negative electrode active material layer 24a in the long side direction Y (width in the winding axis WL direction) is as long as 15 cm or more or 20 cm or more, for example, the b* value is relatively smaller in the end part in the long side direction Y than in the central part in the long side direction Y typically. In the end part in the long side direction Y, the b* value can be less than 3, for example, ½ or less of that in the central part in the long side direction Y.

As illustrated in FIG. 4, the separator 26 is a member that insulates the positive electrode active material layer 22a of the positive electrode 22 and the negative electrode active material layer 24a of the negative electrode 24 from each other. The width of the separator 26 in the winding axis WL direction, that is, a length W3 in the long side direction Y is more than or equal to the length W2 of the negative electrode active material layer 24a in the long side direction Y. The separator 26 is preferably, for example, a porous sheet made of resin including polyolefin resin such as polyethylene (PE) or polypropylene (PP). The separator 26 may include a heat resistance layer (HRL) or an adhesive layer on a surface of a base material part formed by a porous sheet made of resin. For example, the heat resistance layer is a layer including inorganic filler and a binder. The adhesive layer is a layer including a binder. The structures of the heat resistance layer and the adhesive layer may be similar to the conventional structures thereof.

When the separator 26 existing in the central area CA of the electrode body 20 (particularly, a surface on a side facing the negative electrode active material layer 24a) is measured using a spectrophotometer, the b* value in the L*a*b* color system based on JIS Z8781-4: 2013 of Japan Industrial Standard is preferably 2 or less, similarly to the negative electrode active material layer 24a. Although the detailed description is omitted, there is also a positive correlation between the heat generation quantity and the b* value of the separator 26, similarly to the b* value of the negative electrode active material layer 24a. Therefore, by adjusting the b* value of the separator 26 to be a predetermined value or less in addition to the b* value of the negative electrode active material layer 24a, the heat generation quantity of the central area CA can be suppressed more stably.

In the separator 26, the film is formed less easily than in the negative electrode active material layer 24a relatively. Therefore, the b* value of the separator 26 is typically smaller than the b* value of the negative electrode active material layer 24a. From the viewpoint of achieving the effect of the art disclosed herein at the high level, the b* value of the separator 26 is preferably 2 or less, more preferably 1.5 or less, still more preferably 1 or less, and particularly preferably 0.5 or less. The b* value of the separator 26 can be adjusted suitably by the conditions in the electrolyte solution impregnation step (step 2), or the conditions in the first aging step (step 5) after the initial charging, the subsequent second aging step (step 6), and the like in the manufacturing method to be described below, for example, similarly to the b* value of the negative electrode active material layer 24a. In particular, the b* value of the separator 26 can be adjusted suitably by the first aging period in the first aging step or the second aging period in the second aging step.

As illustrated in FIG. 2, the positive electrode current collecting part 50 forms a conductive path for electrically connecting the positive electrode terminal 30 and the positive electrode tab group 23 formed by the plurality of positive electrode tabs 22t. The positive electrode current collecting part 50 may be formed of the same metal species as the positive electrode current collector 22c, for example, a conductive metal such as aluminum, an aluminum alloy, nickel, or stainless steel. The positive electrode current collecting part 50 includes a positive electrode first current collecting part 51 and the positive electrode second current collecting part 52. The positive electrode first current collecting part 51 is attached to an inner surface of the sealing plate 14. The positive electrode second current collecting part 52 extends along the short side wall 12c of the exterior body 12. The positive electrode second current collecting part 52 is attached to the positive electrode tab group 23 of the electrode body 20.

As illustrated in FIG. 2, the negative electrode current collecting part 60 forms a conductive path for electrically connecting the negative electrode terminal 40 and the negative electrode tab group 25 formed by the plurality of negative electrode tabs 24t. The negative electrode current collecting part 60 may be formed of the same metal species as the negative electrode current collector 24c, for example, a conductive metal such as copper, a copper alloy, nickel, or stainless steel. The negative electrode current collecting part 60 includes a negative electrode first current collecting part 61 and the negative electrode second current collecting part 62. The structure and arrangement of the negative electrode first current collecting part 61 and the negative electrode second current collecting part 62 may be similar to those of the positive electrode first current collecting part 51 and the positive electrode second current collecting part 52 of the positive electrode current collecting part 50, respectively. The negative electrode second current collecting part 62 is attached to the negative electrode tab group 25 of the electrode body 20.

As illustrated in FIG. 2, the positive electrode insulating member 70 is a member that insulates the sealing plate 14 and the positive electrode first current collecting part 51. The positive electrode insulating member 70 is made of a resin material that has resistance against the electrolyte solution to be used and an electrical insulating property and that is capable of elastic deformation. For example, the positive electrode insulating member 70 is preferably made of a polyolefin resin such as polypropylene (PP), a fluorinated resin such as tetrafluoroethylene-perfluoroalkoxy ethylene copolymer (PFA), polyphenylene sulfide (PPS), or the like.

As illustrated in FIG. 2, the negative electrode insulating member 80 is a member that insulates the sealing plate 14 and the negative electrode first current collecting part 61. The negative electrode insulating member 80 is disposed to be symmetrical to the positive electrode insulating member 70 about a center CL of the electrode body 20 in the long side direction Y. The material, the structure, and the like of the negative electrode insulating member 80 may be similar to those of the positive electrode insulating member 70.

The nonaqueous electrolyte solution contains a nonaqueous solvent and an electrolyte salt (supporting salt). As the nonaqueous solvent, one kind or two or more kinds of nonaqueous solvents that have conventionally been known as being usable for the nonaqueous electrolyte solution secondary battery can be used. Examples of the nonaqueous solvent include organic solvents such as carbonates, ethers, esters, nitriles, sulfones, and lactones. The nonaqueous solvent preferably includes the carbonates. Examples of the carbonates include chain carbonates such as ethylene carbonate (EC), dimethyl carbonate (DMC), diethyl carbonate (DEC), and ethyl methyl carbonate (EMC) and cyclic carbonates such as propylene carbonate (PC).

The electrolyte salt is not limited to a particular type as long as the charge carriers (typically, lithium ion) are included, and one kind or two or more kinds of electrolyte salts that have conventionally been known as being usable for the nonaqueous electrolyte solution secondary battery can be used. One example of the electrolyte salt is fluorine-containing lithium salt such as LiPF₆ or LiBF₄. The electrolyte salt preferably contains LiPF₆.

The nonaqueous electrolyte solution may further contain an additional component (additive). Examples thereof include a boron-based additive containing a boron element, a phosphorus-based additive containing a phosphorus element, a sulfur-based additive containing a sulfur element, a carbonate-based additive, and the like. These additives may be so-called film formation agents that are decomposed before (at lower potential than) the nonaqueous solvent and/or the electrolyte salt at the initial charging and deposited as a film on the surface of the negative electrode active material layer 24a.

The nonaqueous electrolyte solution preferably contains the boron-based additive, that is, the compound containing the boron element (B element containing compound). As the B element containing compound, one kind or two or more kinds of compounds that have conventionally been known as being able to be added to the nonaqueous electrolyte solution (for example, compound as described in Japanese Patent Application Publication No. 2007-165125) can be used. Examples of the B element containing compound include an oxalato complex compound containing the boron element (B element containing oxalato compound), such as lithium bisoxalate borate (LiBOB) or lithium difluoro(oxalato)borate (LiODFB).

The nonaqueous electrolyte solution preferably further contains the phosphorus-based additive, that is, a compound containing the phosphorus element (P element containing compound). As the P element containing compound, one kind or two or more kinds of compounds that have conventionally been known as being able to be added to the nonaqueous electrolyte solution (for example, compound as described in Japanese Patent Application Publication No. 2007-165125) can be used. Examples of the P element containing compound include an oxalato complex compound containing the phosphorus element (P element containing oxalato compound), such as lithium difluorophosphate (LiPO₂F₂) or lithium difluorooxalate phosphate (LiDFOP).

The nonaqueous electrolyte solution preferably further contains the sulfur-based additive, that is, a compound containing a sulfur element (S element containing compound). As the S element containing compound, one kind or two or more kinds of compounds that have conventionally been known as being able to be added to the nonaqueous electrolyte solution can be used. Examples of the S element containing compound include lithium fluorosulfonate (LiSO₃F), lithium=ethyl=sulfate, lithium bis(trifluoromethanesulfonyl)imide (LiTFSI), lithium bis(fluorosulfonyl)imide (LiFSI), and the like.

The nonaqueous electrolyte solution may further contain a carbonate-based additive. As the carbonate-based additive, one kind or two or more kinds of additives that have conventionally been known as being able to be added to the nonaqueous electrolyte solution as the film formation agent, for example, can be used. Examples of the carbonates include vinylene carbonate (VC), vinyl ethylene carbonate (VEC), fluoroethylene carbonate (FEC), and the like.

Note that the additive in the nonaqueous electrolyte solution (for example, the boron-based additive, the phosphorus-based additive, the sulfur-based additive, or the carbonate-based additive described above) is typically decomposed electrically by the initial charging at the battery manufacture or the like and consumed to form the film on the negative electrode active material layer 24a or the like. Therefore, in the state of the battery 100, the additive as described above may be included (remain) or may not be included in the nonaqueous electrolyte solution.

### Manufacturing Method for Battery 100

For example, the battery 100 can be manufactured by a manufacturing method including the following steps in the following order: a constructing step for a battery assembly (step 1), the electrolyte solution impregnation step (step 2), an initial charging step (step 3), a defoaming step (step 4), the first aging step (step 5), and the second aging step (step 6). However, the electrolyte solution impregnation step (step 2) and the defoaming step (step 4) are optional and can be omitted in another embodiment. Additionally, another step may be included at an optional stage.

In the constructing step (step 1), the electrode body 20 and the nonaqueous electrolyte solution are accommodated in the battery case 10 to construct the battery assembly in a glove box. In this specification, the term “battery assembly” refers to an intermediate object assembled up to the state before the initial charging step (step 3) is performed in the manufacturing process for the battery 100. The order of accommodating the electrode body 20 and the nonaqueous electrolyte solution in the battery case 10 is not limited in particular. For example, after the electrode body 20 is accommodated in the battery case 10, the nonaqueous electrolyte solution may be injected into the battery case 10.

In a preferred embodiment, the present step includes a disposing step (step 1-1), a welding joining step (step 1-2), a drying step (step 1-3), and a liquid injecting step (step 1-4) typically in this order. However, the drying step (step 1-3) is optional and can be omitted in another embodiment. In still another embodiment, the order of the welding joining step (step 1-2) and the drying step (step 1-3) may be opposite and the order of the welding joining step (step 1-2) and the liquid injecting step (step 1-4) may be opposite. In yet still another embodiment, the liquid injecting step (step 1-4) may be performed in multiple stages. Additionally, another step may be included at an optional stage.

In the disposing step (step 1-1), the electrode body 20 is disposed inside the exterior body 12. Specifically, the electrode body 20 is accommodated inside the exterior body 12 through the opening 12h. Next, in the welding joining step (step 1-2), the sealing plate 14 is welded at the periphery of the opening 12h of the exterior body 12 to integrate the exterior body 12 and the sealing plate 14. Then, in the drying step (step 1-3), the exterior body 12 accommodating the electrode body 20 is dried with the liquid injection hole 15 opened, so that the moisture inside the exterior body 12 is removed. In particular, the moisture inside the electrode body 20 is removed. The moisture is removed similarly to the conventional art using a heating and drying device, a vacuum drying device, or the like through operations of heating, decompression, and the like carried out alone or in combination. The heating temperature is preferably set so that the moisture can be evaporated suitably in a decompressed state and the separator of the electrode body 20 and the like do not thermally deteriorate, for example. The heating temperature can be set in the range of, for example, 50 to 200° C.

Next, in the liquid injecting step (step 1-4), first, the nonaqueous electrolyte solution is prepared. The nonaqueous electrolyte solution contains the boron-based additive (B element containing compound) in addition to the nonaqueous solvent and the electrolyte salt. Although not limited in particular, the concentration of the B element containing compound in the nonaqueous electrolyte solution is preferably 0.01 mol/L or more and more preferably 0.05 mol/L or more because the film can be formed with the suitable quantity or quality on the surface of the negative electrode active material layer 24a in the central area CA. On the other hand, from the viewpoint of suppressing the increase in battery resistance, the concentration of the B element containing compound in the nonaqueous electrolyte solution is preferably 1 mol/L or less, more preferably 0.5 mol/L or less, and still more preferably 0.1 mol/L or less.

In addition to the boron-based additive, the nonaqueous electrolyte solution preferably contains another additive, for example, at least one of the phosphorus-based additive, the sulfur-based additive, and the carbonate-based additive described above. The concentration of each additive may be similar to that of the boron-based additive. The prepared nonaqueous electrolyte solution is injected into the battery case 10 through the liquid injection hole 15 of the sealing plate 14. The liquid is injected preferably with the inside of the battery case 10 decompressed in order to improve the impregnation of the electrode body 20 with the nonaqueous electrolyte solution.

In the electrolyte solution impregnation step (step 2), after the constructing step for the battery assembly (specifically, after the liquid injecting step), the impregnation of the inside of the electrode body 20, particularly the central part in the long side direction Y with the nonaqueous electrolyte solution is increased. The present step may be performed in a normal temperature (about 25° C.±10° C.) environment. In a preferred embodiment, the present step includes a first impregnation step (step 2-1), a decompressed impregnation step (step 2-2), and a second impregnation step (step 2-3) in this order. Additionally, another step may be included at an optional stage. The necessary time of the present step (the total time of the first impregnation step, the decompressed impregnation step, and the second impregnation step) is preferably 45 to 200 hours and more preferably 49 to 140 hours.

In the first impregnation step (step 2-1), the battery assembly is left (held) in an atmospheric pressure state for a first impregnation time after the completion of the liquid injection in the constructing step for the battery assembly (specifically, liquid injecting step). The first impregnation time is preferably 25 hours or more. Thus, the viscosity of the nonaqueous electrolyte solution decreases and the impregnation of the inside of the electrode body 20, particularly the central part in the long side direction Y with the nonaqueous electrolyte solution can be promoted.

Next, in the decompressed impregnation step (step 2-2), after the first impregnation step, the battery assembly is accommodated in a chamber in which the pressure can be regulated, and in a state where the liquid injection hole 15 is opened (in other words, a state where there is no pressure difference between the inside and the outside of the battery case 10), the inside of the chamber is decompressed at least once and in the decompressed state, the battery assembly is held for a predetermined time. The pressure in the decompressed state is preferably −0.05 MPa or less, and may be about −0.09 MPa, for example, although depending on the length W2 of the negative electrode active material layer 24a in the long side direction Y or the like, for example. The holding time in the decompressed state is preferably 600 seconds or more, for example, although depending on the length W2 of the negative electrode active material layer 24a in the long side direction Y or the like. For example, the decompression may be performed once, or twice or more with the pressure release conducted between the decompressions. In one example, after the first decompression, the pressure is released from the battery case 10 once to make the pressure normal (−0.01 MPa or more) and after the normal pressure state is held for a predetermined time, the second decompression may be performed. The holding time at the normal pressure is preferably 60 seconds or more and more preferably 100 seconds or more. The number of times of decompressions is preferably two or more and more preferably four or more.

Next, in the second impregnation step (step 2-3), after the decompressed impregnation step, the battery assembly is left (held) in the atmospheric pressure state for a second impregnation time. The second impregnation time is preferably 20 hours or more. The second impregnation time may be shorter than the first impregnation time. Thus, the impregnation of the inside of the electrode body 20, particularly the central part in the long side direction Y with the nonaqueous electrolyte solution can be promoted further.

In the initial charging step (step 3), the battery assembly is charged at least once after the electrolyte solution impregnation step. The battery assembly can be charged similarly to the conventional charging. Typically, an external power source is connected between the positive electrode terminal and the negative electrode terminal of the battery assembly, and charging is performed until the voltage between the positive and negative electrode terminals becomes a predetermined attainment voltage. The attainment voltage is set so that at least the B element containing compound in the nonaqueous electrolyte solution is electrically decomposed. In one example, in a case where the negative electrode active material is a carbon material, the attainment voltage may be set to about 2.5 V or more, preferably 3 V or more, for example 3.5 V or more, and 4 V or more. The charging rate may be, for example, about 0.1 C to 2 C. For example, the charging may be performed once, or twice or more with the discharging conducted between the charging processes.

By the initial charging, the additive in the nonaqueous electrolyte solution (at least the B element containing compound) is electrolyzed before the other components (nonaqueous solvent or electrolyte salt) in the nonaqueous electrolyte solution typically. Thus, the film (SEI film) including the decomposition product of at least the B element containing compound is formed on the surface of the negative electrode active material layer 24a.

In the defoaming step (step 4), after the initial charging step, the gas in the battery case 10, for example air, gas generated by the decomposition of the nonaqueous electrolyte solution in the initial charging step, and the like are discharged to the outside of the battery case 10. The gas can be discharged by, for example, decompressing the inside of the battery case 10. Then, the liquid injection hole 15 is sealed with the sealing member 16 preferably with the inside of the battery case 10 decompressed. Thus, the battery case 10 is hermetically sealed (closed).

In the first aging step (step 5), the battery assembly after the initial charging is restricted and held for the predetermined first aging period with a predetermined restriction load applied from the short side direction X (the thickness direction of the electrode body 20) under a predetermined temperature environment. The temperature environment is preferably 15 to 40° C., and may be, for example, normal temperature (about 25° C.±10° C.). The restriction load may be 1 to 6 kN. In a preferred embodiment, first, a cell pressing machine including a pair of restriction plates is prepared. Next, the battery assembly after the initial charging is disposed between the pair of restriction plates so that the pair of long side walls 12b of the battery case 10 face the restriction plates, and in this state, the restriction load is applied to the battery assembly after the initial charging by the pressing machine, and the obtained battery assembly is held for the predetermined first aging period. Note that in the present step, the voltage adjusted in the initial charging step may be maintained. In the present step, the state of charge (SOC) of the battery is typically lower than that in the second aging step (step 6) to be described below, and may be, for example, 20% or less and 10% or less.

The present inventors' examination indicates that there is a negative correlation between the first aging period of the present step and the b* value of the negative electrode active material layer 24a obtained in the measurement with a spectrophotometer, which will be described in detail in Example below. That is to say, as the first aging period of the present step becomes longer, the b* value of the negative electrode active material layer 24a existing in the central area CA of the electrode body 20 tends to become smaller. Similarly, the b* value of the separator 26 also tends to become smaller as the first aging period of the present step becomes longer. Therefore, the first aging period is preferably about five days or more and more preferably six days or more, for example, although depending on the length W2 of the negative electrode active material layer 24a in the long side direction Y, the conditions in the electrolyte solution impregnation step (step 2), and the like. When the first aging period is a predetermined period or more, it becomes easy to adjust the b* value of the negative electrode active material layer 24a to be within the aforementioned range (for example, 3 or less). In addition, it becomes easy to adjust the b* value of the separator 26 to be within the aforementioned range (for example, 2 or less).

Next, in the second aging step (step 6), after the battery assembly is charged up to a predetermined SOC, preferably until the SOC becomes 10% to 30%, the battery assembly is held for the predetermined second aging period under a higher temperature environment than in the first aging step (step 5). The temperature environment in the present step is preferably 50 to 90° C., and may be 70° C.±10° C., for example. The second aging period is preferably about 6 to 24 hours although depending on, for example, the length W2 of the negative electrode active material layer 24a in the long side direction Y, the conditions in the electrolyte solution impregnation step (step 2), the first aging period in the first aging step (step 5), and the like. Note that the state of charge (SOC) refers to a charging state (charging ratio) based on the voltage range where the battery 100 is normally used. The battery 100 can be manufactured suitably as above.

### Inspection Method for Negative Electrode 24 or Separator 26

For example, the battery assembly after the initial charging or the battery 100 for which the process up to the second aging step has been performed is subjected to quality management about the thermal stability in the form of acceptance sampling. In the acceptance sampling, the negative electrode 24 or the separator 26 can be the subject of the sampling. In view of this, in the inspection method disclosed herein, the battery assembly (or battery 100) that has been subjected to at least the constructing step (step 1), the initial charging step (step 3), the first aging step (step 5), and the second aging step (step 6) in the aforementioned manufacturing method is then subjected to the subsequent steps of a disassembling step (step 7) of disassembling the battery assembly and a color measuring step (step 8) of measuring the b* value in this order. In the present embodiment, an evaluation step (step 9) of evaluating the thermal stability of the battery assembly or the battery 100 is also performed. Additionally, another step may be included at an optional stage.

In the disassembling step (step 7), the battery assembly is disassembled. The battery assembly is preferably disassembled in a dry air (for example, with a dew point of about −50° C.) atmosphere, for example in a glove box in order to avoid the degeneration of the negative electrode 24 or the separator 26. The battery assembly can be disassembled in a manner that, for example, first, the battery case 10 is cut with a tool such as an end mill, a laser, or the like to separate the sealing plate 14 from the exterior body 12, and moreover the electrode body 20 is extracted from the inside of the exterior body 12. Moreover, the winding of the extracted electrode body 20 is unfastened, so that the electrode body 20 can be separated into the positive electrode 22, the negative electrode 24, and the separator 26.

In the color measuring step (step 8), after the disassembling step, the b* value in the L*a*b* color system based on JIS Z8781-4: 2013 of Japan Industrial Standard is measured using a spectrophotometer about the negative electrode active material layer 24a or the separator 26 (typically surface) existing in the central area CA of the electrode body 20. The measurement may be performed a plurality of times in consideration of variation. In that case, the arithmetic mean of a plurality of measurement values can be employed as the b* value. As described above, there is a positive correlation between the b* value of the negative electrode active material layer 24a in the central area CA of the electrode body 20 and the heat generation quantity of the battery 100. Similarly, there is a positive correlation between the b* value of the separator 26 in the central area CA of the electrode body 20 and the heat generation quantity of the battery 100. Therefore, by measuring the b* value of the negative electrode active material layer 24a or the separator 26, the thermal stability (heat generation behavior) of the battery 100 can be predicted or confirmed.

In the evaluation step (step 9), the thermal stability of the battery assembly or the battery 100 is evaluated. In a preferred aspect, the correlation between the b* value and the heat generation quantity of the battery 100 is represented by an expression (for example, linear function given in Example) or the like in advance by a preliminary test or the like, and by assigning the b* value to the expression, the heat generation quantity of the battery 100 is predicted. In another preferred aspect, whether the product is good or bad is determined based on the b* value of the negative electrode active material layer 24a and/or the b* value of the separator 26. For example, the product is determined to be good when the b* value of the negative electrode active material layer 24a and/or the b* value of the separator 26 is less than or equal to a predetermined value. In one example, the product is determined to be good when the b* value of the negative electrode active material layer 24a is 3 or less. In another example, the product is determined to be good when the b* value of the separator 26 is 2 or less. In the battery assembly that is determined to be good in this case, the heat generation quantity can be suppressed and the variation in thermal stability can be made small. Thus, the upper limit of the heat generation quantity of the battery 100 can be controlled suitably and the battery 100 with high reliability can be supplied to the market.

### Application of Battery 100

The battery 100 is usable in various applications, and can be suitably used as a motive power source for a motor (power source for driving) that is mounted in a vehicle such as a passenger car or a truck because of having the high capacity and the excellent thermal stability, for example. The vehicle is not limited to a particular type, and may be, for example, a plug-in hybrid electric vehicle (PHEV), a hybrid electric vehicle (HEV), or a battery electric vehicle (BEV). The battery 100 can also be suitably used as a battery pack in which the plurality of batteries 100 are arranged in a predetermined arrangement direction and a load is applied from the arrangement direction by a restriction mechanism.

Several Examples relating to the present disclosure will be explained below, but the present disclosure is not meant to be limited to these Examples.

### TEST EXAMPLE I (EXAMPLES 1 AND 2 AND COMPARATIVE EXAMPLES 1 TO 5)

### Evaluation on Color Unevenness

First, in the constructing step (step 1), the electrode body and the nonaqueous electrolyte solution with the composition shown in Table 1 were accommodated in the battery case and thus, the battery assembly was constructed. Note that the flat part of the negative electrode active material layer had a length of 285 mm in the winding axis direction (width direction) and a height of 90 mm. Next, in the electrolyte solution impregnation step (step 2), first, the battery assembly was left for 25 hours (first impregnation time) after the completion of the liquid injection. Subsequently, the inside of the battery case was decompressed to −0.09 MPa and in this state, the battery case was held for 600 seconds; then, the pressure in the battery case was restored to 0 MPa and in this state, the battery case was held for 60 seconds. This process was performed four times in total. Next, the battery assembly was left for 20 hours (second impregnation time).

Subsequently, in the initial charging step (step 3), constant-current charging was performed at a charging rate of 1 C to 3 V. Next, in the defoaming step (step 4), the inside of the battery case was decompressed to −0.09 MPa. Next, in the first aging step (step 5), the battery assembly after the initial charging to which a restriction load of 4 kN was applied was held in a 25° C.-temperature environment for the first aging period shown in Table 1. Subsequently, after the first aging step (step 5), the battery assembly was charged until the SOC became 20%, and in the second aging step (step 6), the battery assembly was left for the predetermined second aging period in a 70° C.-temperature environment. After that, in the disassembling step (step 7), the battery assembly after the second aging step was disassembled in a glove box and the electrode body was extracted from the battery case. Then, the winding of the electrode body extracted from the battery case was unfastened, so that the positive electrode, the negative electrode, and the separator were separated.

Next, in the color measuring step (step 8), the color unevenness of the negative electrode active material layer in the central area of the electrode body was observed with human eyes, the surface of the negative electrode active material layer in the central area of the electrode body was measured using a spectrophotometer (model type: CM-26dG) of a diffusion illumination type manufactured Konica Minolta, Inc. by a specular component include (SCI) method of taking in regular reflection light with a trap of the regular reflection light, and the b* value in the L*a*b* color system based on JIS Z8781-4: 2013 of Japan Industrial Standard was measured. The observation position with the eyes and the measurement position with the spectrophotometer were the flat part present at the 15th turn (intermediate periphery) from a winding start end part. In some examples, the separator was also observed and measured similarly to the negative electrode active material layer. The results are shown in Table 1.

### Evaluation on Heat Generation Quantity

First, a sample for DSC measurement was manufactured. Specifically, first, the positive electrode including the positive electrode active material layer (a square of 20 mm×20 mm) and the negative electrode including the negative electrode active material layer (a square of 22 mm×22 mm) were disposed so as to face each other through the separator in a dry air (dew point: −50° C.) atmosphere, and were accommodated together with 0.4 mL of the nonaqueous electrolyte solution with the composition shown in Table 1, so that a laminate cell was constructed.

Next, after the manufactured laminate cell was charged with constant current to 4.25 V at a current value of 8 mA, the laminate cell was charged with constant voltage for five hours. Next, in a glove box (Ar atmosphere), the charged laminate cell was disassembled. Next, the electrolyte solution was taken out and the positive electrode and the negative electrode were extracted. A positive electrode mixture was peeled from the central area of the positive electrode active material layer and a negative electrode mixture was peeled from the central area of the negative electrode active material layer. Then, 1 mg of the positive electrode mixture peeled from the positive electrode, 2 mg of the negative electrode mixture peeled from the negative electrode, and 4 mg of the taken electrolyte solution were accommodated in a sample container. This sample container was sealed by pressing at 20 MPa, and then set to a differential scanning calorimetry (DSC) together with a standard material (Al₂O₃, 2 mg). Subsequently, the temperature was increased at a temperature increasing rate of 2° C./min from 25° C. to 350° C. under an inert atmosphere and the heat generation quantity (J) between 100 to 200° C. was obtained by integration. The results are shown in Table 1.

TABLE 1

| | | | | | | | | | | | Color unevenness in central area of | | |
|---|---|---|---|---|---|---|---|---|---|---|---|---|---|
| | | | | | | | | | | | wound electrode body | | |
| | | | | | | | | | | | Negative electrode active | | |
| | Nonaqueous electrolyte solution | | | | | | | | | Battery | material layer | | Separator |
| | | | | | | | | Electrolyte | First | Heat | | b* value | b* value |
| | Additive | | | | Nonaqueous solvent | | | salt | aging | generation | Observation | in L*a*b* | in L*a*b* |
| | LiBOB | LiSO₃F | LIPO₂F₂ | VC | EMC | DMC | EC | LiPF₆ | period | quantity | with human | color | color |
| | (mol/L) | (mol/L) | (mol/L) | (mol/L) | (moVL) | (mol/L) | (mol/L) | (mol/L) | (days) | (J) | eyes | system | system |
| Comparative | 0.05 | 0.18 | 0.06 | 0.14 | 2.70 | 4.39 | 4.15 | 1.10 | 0 | 45 | Dense color | — | — |
| Example 1 | | | | | | | | | | | unevenness | | |
| | | | | | | | | | | | was observed | | |
| Comparative | 0.05 | 0.18 | 0.06 | 0.14 | 2.70 | 4.39 | 4.15 | 1.10 | 1 | 30 | Dense color | — | — |
| Example 2 | | | | | | | | | | | unevenness | | |
| | | | | | | | | | | | was observed | | |
| Comparative | 0.05 | 0.18 | 0.06 | 0.14 | 2.70 | 4.39 | 4.15 | 1.10 | 2 | 22 | Dense color | 4.02 | 3.2 |
| Example 3 | | | | | | | | | | | unevenness | | |
| | | | | | | | | | | | was observed | | |
| Comparative | 0.05 | 0.18 | 0.06 | 0.14 | 2.70 | 4.39 | 4.15 | 1.10 | 3 | 19 | Depending | 3.16 | — |
| Example 4 | | | | | | | | | | | on people | | |
| Comparative | 0.05 | 0.18 | 0.06 | 0.14 | 2.70 | 4.39 | 4.15 | 1.10 | 4 | 18 | Depending | 3.30 | 2.1 |
| Example 5 | | | | | | | | | | | on people | | |
| Example 1 | 0.05 | 0.18 | 0.06 | 0.14 | 2.70 | 4.39 | 4.15 | 1.10 | 5 | 17 | None | 2.43 | — |
| Example 2 | 0.05 | 0.18 | 0.06 | 0.14 | 2.70 | 4.39 | 4.15 | 1.10 | 6 | 14 | None | 1.45 | 0.2 |

As shown in Table 1, the dense color unevenness of the negative electrode active material layer was observed with human eyes in Comparative Example 1 in which the first aging period was zero days (none) and Comparative Example 2 in which the first aging period was one day. Therefore, the measurement with a spectrophotometer was omitted. Moreover, the dense color unevenness of the negative electrode active material layer was observed also in Comparative Example 3 in which the first aging period was two days. On the other hand, in Comparative Examples 4 and 5, the determination as to whether there was color unevenness varied depending on people.

FIG. 5 expresses the relation between the first aging period in the first aging step (step 5) and the b* value of the negative electrode active material layer in the central area of the electrode body about Comparative Examples 3 to 5 and Examples 1 and 2. As expressed in FIG. 5, there is a strong negative correlation of R²=0.9 or more between the first aging period and the b* value of the negative electrode active material layer. That is to say, as the aging period became longer, the b* value became smaller. Therefore, it has been understood that the b* value can be adjusted suitably by the length of the aging period. Moreover, here, when the first aging period was five days as described in Example 1, the b* value of the negative electrode active material layer was able to be made 3 or less; when the first aging period was six days as described in Example 2, the b* value of the negative electrode active material layer was able to be made 2 or less.

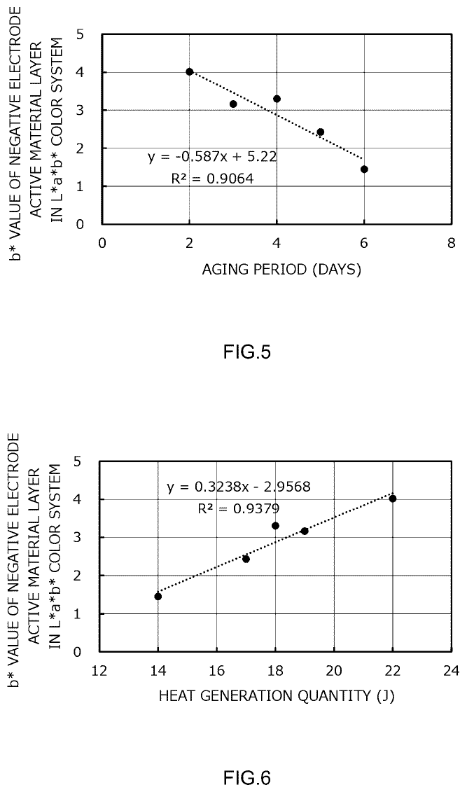

FIG. 6 expresses the relation between the heat generation quantity of the battery and the b* value of the negative electrode active material layer in the central area of the electrode body about Comparative Examples 3 to 5 and Examples 1 and 2. As expressed in FIG. 6, there is a very strong positive correlation of R²=0.93 or more between the heat generation quantity of the battery and the b* value of the negative electrode active material layer. That is to say, as the b* value became larger, the heat generation quantity became larger. Therefore, it has been understood that when the b* value of the negative electrode active material layer was a predetermined value or less (for example, 3 or less), the heat generation quantity was suppressed (for example, to 17 J or less and preferably 15 J or less) and the thermal stability of the battery was improved.

The present inventors measured the boron concentration ratio (B concentration ratio) about the negative electrode active material layer in the central area of the electrode body in each Example and as a result, the correlation as strong as that in FIG. 6 was not observed between the heat generation quantity and the B concentration ratio, which will not be described in detail. The reason is not clear but it is considered, from the measurement results of the ICP spectrometry about the nonvolatile component, that the negative electrode active material layer in the central area of the electrode body includes a large amount of films derived from the decomposed solvent and the films vary in quality, for example. Thus, it has been suggested that the b* value is the parameter reflecting not just the concentration of boron in the film but also the state of the formation of the film (quality of film). Accordingly, simply measuring the B concentration ratio was not enough and evaluating with the b* value as described in the art disclosed herein was considered important.

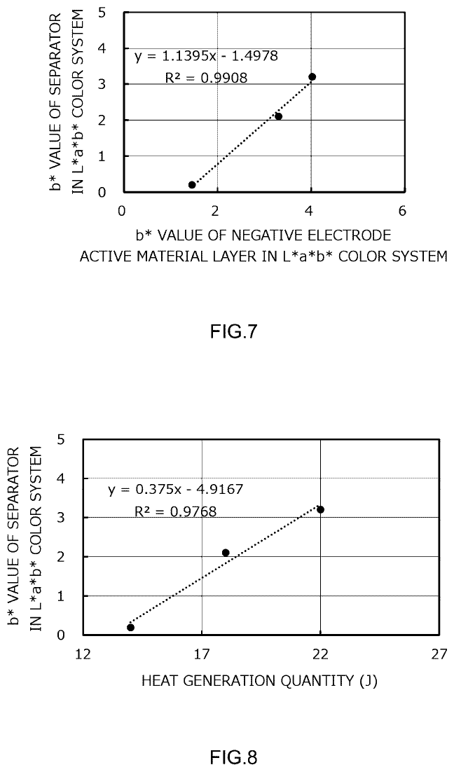

FIG. 7 expresses the relation between the b* value of the negative electrode active material layer and the b* value of the separator about Comparative Examples 3 and 5 and Example 2. As expressed in FIG. 7, a very strong correlation of R²=0.99 or more was observed between the b* value of the negative electrode active material layer and the b* value of the separator although the measurement points were three. This has indicated that it is also possible to use the b* value of the separator instead of the b* value of the negative electrode active material layer. In addition, it has also been understood that the b* value of the separator is smaller than the b* value of the negative electrode active material layer.

FIG. 8 expresses the relation between the heat generation quantity of the battery and the b* value of the separator about Comparative Examples 3 and 5 and Example 2. As expressed in FIG. 8, a very strong positive correlation of R²=0.97 or more was observed between the heat generation quantity of the battery and the b* value of the separator. That is to say, as the b* value was larger, the heat generation quantity was larger, similarly to the case of the negative electrode active material layer. Thus, it has been understood that making the b* value of the separator less than or equal to a predetermined value (for example, 2 or less, furthermore 1.5 or less) can suppress the heat generation quantity (for example, 17 J or less, preferably 15 J or less) and can improve the thermal stability of the battery.

### TEST EXAMPLE II (EXAMPLES 3 TO 5)

The color unevenness and the heat generation quantity of the negative electrode active material layer existing in the central area of the electrode body were measured similarly to Example 2 of Test Example I except that the nonaqueous electrolyte solution with the composition shown in Table 2 was used. The results are shown in Table 2. Note that Table 2 also shows the results of Example 2 of Test Example I.

TABLE 2

| | | | | | | | | | | | Color unevenness | |
|---|---|---|---|---|---|---|---|---|---|---|---|---|
| | | | | | | | | | | | in negative electrode | |
| | Nonaqueous electrolyte solution | | | | | | | | | Battery | active material layer | |
| | | | | | | | | Electrolyte | First | Heat | | b* value |
| | Additive | | | | Nonaqueous solvent | | | salt | aging | generation | Observation | in L*a*b* |
| | LiBOB | LiSO₃F | LiPO₂F₂ | VC | EMC | DMC | EC | LiPF₆ | period | quantity | with human | color |
| | (mol/L) | (mol/L) | (mol/L) | (mol/L) | (mol/L) | (mol/L) | (mol/L) | (mol/L) | (days) | (J) | eyes | system |
| Example 2 | 0.05 | 0.18 | 0.06 | 0.14 | 2.70 | 4.39 | 4.15 | 1.10 | 6 | 14 | None | 1.45 |
| Example 3 | 0.05 | 0 | 0.06 | 0.15 | 2.70 | 4.43 | 4.21 | 1.12 | 6 | 15 | None | 1.79 |
| Example 4 | 0.05 | 0.17 | 0 | 0.15 | 2.68 | 4.41 | 4.18 | 1.12 | 6 | 14 | None | 1.70 |
| Example 5 | 0.05 | 0.17 | 0.06 | 0 | 2.70 | 4.43 | 4.22 | 1.12 | 6 | 14 | None | 1.59 |

In Example 3 in which lithium fluorosulfonate (LiSO₃F) was not added, Example 4 in which lithium difluorophosphate (LiPO₂F₂) was not added, and Example 5 in which vinylene carbonate (VC) was not added, the heat generation quantity was substantially the same as that in Example 2 as shown in Table 2. Therefore, from the viewpoint of the heat generation quantity, it is only necessary that the compound containing the boron element (here, lithium bisoxalate borate (LiBOB)) is included in the nonaqueous electrolyte solution as the additive, and it is indicated that the other additives are not essential. Moreover, it is understood that the b* value of the negative electrode active material layer can also vary somewhat depending on the composition of the nonaqueous electrolyte solution (for example, the kind and the quantity of additives).

Although some embodiments of the present disclosure have been described above, these embodiments are just examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

As described above, the following items are given as specific aspects of the art disclosed herein.

Item 1: The nonaqueous electrolyte solution secondary battery including the electrode body in which the positive electrode and the negative electrode are stacked across the separator, the nonaqueous electrolyte solution, and the battery case that accommodates the electrode body and the nonaqueous electrolyte solution, in which the negative electrode includes the negative electrode current collector and the negative electrode active material layer fixed on the negative electrode current collector, the negative electrode active material layer includes the film containing the boron element, and when the negative electrode active material layer existing in the central area of the electrode body is measured using the spectrophotometer, the b* value in the L*a*b* color system based on JIS Z8781-4: 2013 of Japan Industrial Standard is 3 or less.
Item 2: The nonaqueous electrolyte solution secondary battery according to Item 1, in which the electrode body is the wound electrode body in which the positive electrode with a band shape and the negative electrode with a band shape are stacked across the separator with a band shape and wound, and the width of the negative electrode active material layer in the winding axis direction of the wound electrode body is 15 cm or more.
Item 3: The nonaqueous electrolyte solution secondary battery according to Item 1 or 2, in which when the separator existing in the central area of the electrode body is measured using the spectrophotometer, the b* value is 2 or less.
Item 4: The nonaqueous electrolyte solution secondary battery according to any one of Items 1 to 3, in which the nonaqueous electrolyte solution includes the compound containing the boron element.
Item 5: The inspection method for a negative electrode for a nonaqueous electrolyte solution secondary battery, including: the constructing step of constructing the battery assembly by accommodating, in the battery case, the electrode body in which the positive electrode including the positive electrode active material layer and the negative electrode including the negative electrode active material layer are stacked across the separator, and the nonaqueous electrolyte solution including the solvent, the electrolyte salt, and the compound containing the boron element; the charging step of charging the battery assembly until at least the compound containing the boron element is decomposed; the disassembling step of disassembling the battery assembly after the charging step; and the color measuring step of, after the disassembling step, measuring the b* value in the L*a*b* color system based on JIS Z8781-4: 2013 of Japan Industrial Standard about the negative electrode active material layer existing in the central area of the electrode body using the spectrophotometer.

### Reference Signs List

10 Battery case
20 Electrode body (wound electrode body)
22 Positive electrode
24 Negative electrode
24a Negative electrode active material layer
24c Negative electrode current collector
26 Separator
100 Battery

What is claimed is:

1. A nonaqueous electrolyte solution secondary battery comprising an electrode body in which a positive electrode and a negative electrode are stacked across a separator, a nonaqueous electrolyte solution, and a battery case that accommodates the electrode body and the nonaqueous electrolyte solution, wherein
the negative electrode includes a negative electrode current collector and a negative electrode active material layer fixed on the negative electrode current collector,
the negative electrode active material layer includes a film containing a boron element, and
when the negative electrode active material layer existing in a central area of the electrode body is measured using a spectrophotometer, a b* value in an L*a*b* color system based on JIS Z8781-4: 2013 of Japan Industrial Standard is 3 or less.

2. The nonaqueous electrolyte solution secondary battery according to claim 1, wherein
the electrode body is a wound electrode body in which the positive electrode with a band shape and the negative electrode with a band shape are stacked across the separator with a band shape and wound, and
a width of the negative electrode active material layer in a winding axis direction of the wound electrode body is 15 cm or more.

3. The nonaqueous electrolyte solution secondary battery according to claim 1, wherein when the separator existing in the central area of the electrode body is measured using the spectrophotometer, the b* value is 2 or less.

4. The nonaqueous electrolyte solution secondary battery according to claim 1, wherein the nonaqueous electrolyte solution includes a compound containing the boron element.

5. An inspection method for a negative electrode for a nonaqueous electrolyte solution secondary battery, comprising:
a constructing step of constructing a battery assembly by accommodating, in a battery case, an electrode body in which a positive electrode including a positive electrode active material layer and a negative electrode including a negative electrode active material layer are stacked across a separator, and a nonaqueous electrolyte solution including a solvent, an electrolyte salt, and a compound containing a boron element;
a charging step of charging the battery assembly until at least the compound containing the boron element is decomposed;
a disassembling step of disassembling the battery assembly after the charging step; and
a color measuring step of, after the disassembling step, measuring a b* value in an L*a*b* color system based on JIS Z8781-4: 2013 of Japan Industrial Standard about the negative electrode active material layer existing in a central area of the electrode body using a spectrophotometer.
